(19) United States
(12) Patent Application Publication
(10) Pub. No.: US 2015/0176530 A1
(43) Pub. Date: Jun. 25, 2015

(54) ULTRA HIGH OVERALL PESSURE RATIO GAS TURBINE ENGINE

(71) Applicant: United Technologies Corporation, Hartford, CT (US)

(72) Inventors: Frederick M. Schwarz, Glastonbury, CT (US); Gabriel L. Suciu, Glastonbury, CT (US)

(73) Assignee: United Technologies Corporation, Hartford, CT (US)

(21) Appl. No.: 14/134,281

(22) Filed: Dec. 19, 2013

(51) Int. Cl. F02K 3/02; F02C 3/13; F02K 3/077; F02K 3/075; F02C 3/107

(52) U.S. Cl. CPC F02K 3/025; F02K 3/075; F02C 3/107; F02K 3/077; F02C 3/13

(57) ABSTRACT

A gas turbine engine comprises a first turbine rotor positioned upstream of a second intermediate turbine rotor and a third turbine rotor positioned downstream of the first and second turbine rotors. A fan rotor and three compressor rotors, with an upstream one of the compressor rotors are connected to rotate on a shaft with a fan drive turbine and a reduced speed fan rotor through a gear reduction. A second intermediate compressor rotor for being driven by the second intermediate turbine rotor, and a third compressor rotor downstream of the first and second compressor rotors and for being driven by the first turbine rotor.

### BACKGROUND OF THE INVENTION

This application relates to a gas turbine engine having three turbine sections.

Gas turbine engines are known and typically include a fan delivering air as propulsion air into a bypass duct and also into a core engine flow where it passes to a compressor. There may be two compressor stages and the air may be compressed and delivered into a combustor section where it may be mixed with fuel and ignited.

Products of the combustion can pass downstream over turbine rotors.

There are two basic architectures in gas turbine engines. In one, there are two turbine rotors with the downstream fan drive turbine rotor driving a lower pressure compressor rotor and the fan. In a second architecture, there are three turbine rotors with one driving the fan alone, one driving a lower pressure compressor, and one driving a high pressure compressor.

Historically, a fan drive turbine has rotated at the same speed as the fan. More recently, gear reductions have been proposed between the fan drive turbine and the fan.

### SUMMARY OF THE INVENTION

In a featured embodiment, a gas turbine engine comprises a first turbine rotor positioned upstream of a second intermediate turbine rotor and a third turbine rotor positioned downstream of the first and second turbine rotors. A fan rotor and three compressor rotors, with an upstream one of the compressor rotors are connected to rotate on a shaft with a fan drive turbine and a reduced speed fan rotor through a gear reduction. A second intermediate compressor rotor for being driven by the second intermediate turbine rotor, and a third compressor rotor downstream of the first and second compressor rotors and for being driven by the first turbine rotor.

In another embodiment according to the previous embodiment, a variable turbine vane is positioned upstream of the first turbine rotor to allow the selective control of an overall pressure ratio.

In another embodiment according to any of the previous embodiments, the variable turbine vane is utilized to reduce an overall pressure ratio at take-off conditions.

In another embodiment according to any of the previous embodiments, an overall pressure ratio can be defined across the second and third compressor rotors as being greater than or equal to about 18.0 and less than or equal to about 36.0.

In another embodiment according to any of the previous embodiments, the second compressor rotor provides a compression ratio greater than or equal to about 8.0 and less than or equal to about 10.0.

In another embodiment according to any of the previous embodiments, the third compressor rotor provides a compression ratio of greater than or equal to about 4.0 and less than or equal to about 6.0.

In another embodiment according to any of the previous embodiments, the first compressor rotor provides a compression ratio of greater than or equal to about 2.5 and less than or equal to about 4.0.

In another embodiment according to any of the previous embodiments, an overall pressure ratio across the three compressor rotors is greater than or equal to about 45.0.

In another embodiment according to any of the previous embodiments, the overall pressure ratio across the three compressor rotors is less than or equal to about 144.0.

In another embodiment according to any of the previous embodiments, the fan rotor delivers air into a bypass duct as propulsion air and to the first compressor rotor as core air flow. A ratio of the bypass air flow to the core air flow is greater than or equal to about 10.0.

In another embodiment according to any of the previous embodiments, the gear ratio across the gear reduction is greater than or equal to about 2.6.

In another embodiment according to any of the previous embodiments, an overall pressure ratio can be defined across the second and third compressor rotors as being greater than or equal to about 18.0 and less than or equal to about 36.0.

In another embodiment according to any of the previous embodiments, the second compressor rotor provides a compression ratio greater than or equal to about 8.0 and less than or equal to about 10.0.

In another embodiment according to any of the previous embodiments, the third compressor rotor provides a compression ratio of greater than or equal to about 4.0 and less than or equal to about 6.0.

In another embodiment according to any of the previous embodiments, the first compressor rotor provides a compression ratio of greater than or equal to about 2.5 and less than or equal to about 4.0.

In another embodiment according to any of the previous embodiments, an overall pressure ratio across the three compressor rotors is greater than or equal to about 45.0.

In another embodiment according to any of the previous embodiments, the overall pressure ratio across the three compressor rotors is less than or equal to about 144.0.

In another embodiment according to any of the previous embodiments, the fan rotor delivers air into a bypass duct as propulsion air and to the first compressor rotor as core air flow. A ratio of the bypass air flow to the core air flow is greater than or equal to about 10.0.

In another embodiment according to any of the previous embodiments, the gear ratio across the gear reduction is greater than or equal to about 2.6.

In another featured embodiment, a method of providing a gas turbine engine comprises the steps of designing a gas turbine engine including three turbine rotors, each driving one of three compressor rotors. An upstream one of the compressor rotors is connected to a gear reduction to drive a fan rotor. A situation is identified wherein an overall pressure ratio and core airflow needed for a gas turbine engine does not require the three compressor rotors and eliminates the upstream one of the compressor rotors and utilizes the gas turbine engine without the upstream one of the compressor rotors

In another embodiment according to the previous embodiment, the resulting engine and the original engine have 80% common parts aft of a flange at the front of an intermediate pressure compressor.

These and other features may be best understood from the following drawings and specification.

### BRIEF DESCRIPTION OF THE DRAWINGS

FIG. 1 schematically shows a gas turbine engine incorporating a unique architecture.

### DETAILED DESCRIPTION

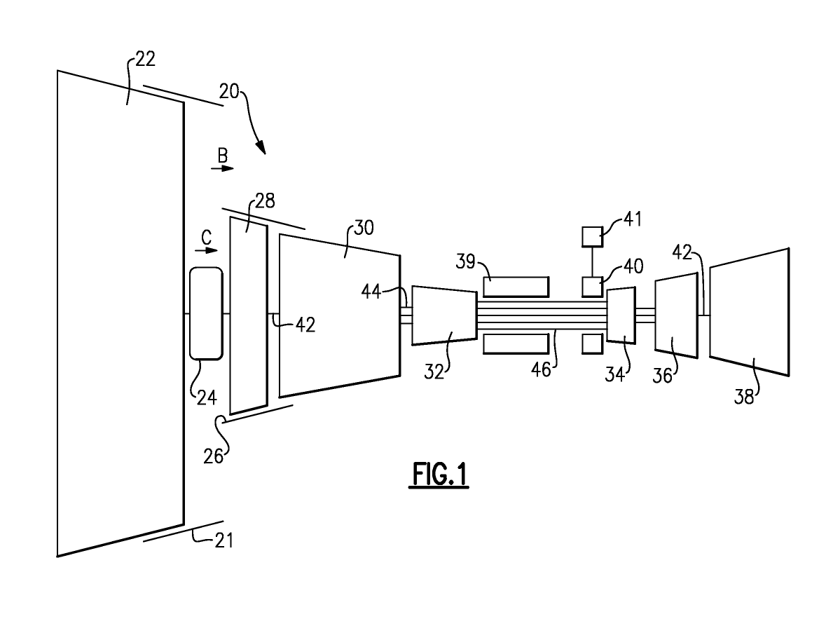

A gas turbine engine 20 is schematically illustrated in FIG. 1. A fan rotor 22 rotates within a nacelle or housing 21 and delivers air as bypass air B which provides propulsion to an aircraft carrying the engine 20. The fan also delivers air into a core flow as core air flow C. The core air flow reaches a first stage compressor rotor 28. This may be seen as a booster compressor. The compressor rotor 28 compresses the air and delivers it into a second stage compressor rotor 30 and, then, into a third stage compressor rotor 32.

The compressed air is delivered into a combustion section 39, shown schematically, and products of this combustion pass downstream across a first higher pressure turbine rotor 34, a second intermediate pressure turbine rotor 36, and a third lower pressure turbine rotor 38. The lower pressure turbine rotor 38 is a fan drive turbine rotor and includes a shaft 42 that drives the first compressor rotor 28 at the same speed as the fan drive turbine and also drives the fan rotor 22 through a gear reduction 24. The intermediate turbine rotor 36 drives the compressor rotor 30 through a shaft 44.

The higher pressure turbine rotor 34 drives the higher pressure compressor rotor 32 through a shaft 46.

In embodiments, the turbine rotor 34 may have a single stage, the turbine rotor 36 may have one to three stages, and the turbine rotor 38 may have three to six stages. A pressure ratio provided across the combination of the compressor rotors 30 and 32 may be greater than or equal to about 18.0 and less than or equal to about 36.0. The compressor rotor 30 may provide a pressure ratio of greater than or equal to about 8.0 and less than or equal to about 10.0. The compressor rotor 32 may provide a pressure ratio of greater than or equal to about 4.0 and less than or equal to about 6.0. A compression ratio across the compressor rotor 28 may be greater than or equal to about 2.5 and less than or equal to about 4.0. The pressure ratios are at sea level take off with the engine at zero forward velocity.

An overall pressure ratio across all three compressor rotors 28, 30, 32 can be achieved that is greater than or equal to about 45 and less than or equal to about 144.0.

Notably, an optional variable turbine vane 40 is shown schematically downstream of the combustor 39 and upstream of the turbine rotor 34. This vane 40 can be utilized to reduce the overall pressure ratio, such as at take-off conditions where it would be desirable to have a lower pressure ratio. This is valuable as the overall pressure ratio with the present invention can be extremely high at cruise (when air entering the engine has a total temperature of around 0.0 degrees Fahrenheit), but that same overall pressure ratio is not possible at take-off, because the resulting temperature levels in rear sections of the high pressure compressor may be too challenging for some disk and hub materials. Also, the extremely elevated temperatures in the compressor would be even further magnified across the combustor and into the high pressure turbine causing oxidation damage to turbine airfoils during take-off. The variable turbine vane would dramatically reduce this damage and that damage would not occur at cruise with the vane closed due to the much more benign inlet temperatures.

A control 41 is shown, and may change the flow area of the variable turbine vane 40 to be open at take-off and climb and closed during cruise. At cruise, with the vane closed, the compressor is back-pressured by the resistance to flow downstream to the turbine rotor 34. In turn this will increase the overall pressure ratio during cruise. The complexity of this system lends itself to a very long range aircraft where reducing cruise fuel consumption is of paramount importance from an economic standpoint.

A gear ratio for the gear reduction 24 is greater than or equal to 2.9 A bypass ratio may be defined as the volume of air delivered as bypass air B compared to the volume of air delivered into the core air flow C. The bypass ratio may be greater than or equal to about 10.0.

The disclosed architecture has valuable benefits in providing the third compressor rotor to provide some of the work. Further, the compressor rotor 30 provides more of the work than does the high pressure compressor rotor 32. In this way, the compressor rotor 32 may rotate at slower speeds which is desirable since at the high overall pressure ratios that this engine is capable of, the temperatures in the back sections of the high pressure compressor are so high that there is a need to reduce stresses in the disks and connecting hubs in the back of the compressor.

One major limitation on compressor design for gas turbine engines is the temperatures experienced at a downstream end of the highest pressure compressor rotor. To achieve high overall pressure ratios, this temperature can be a limitation. As an example, material temperature limits at this rear stage must be able to withstand the temperatures seen at the highest stress conditions and, namely, take-off.

By providing the booster compressor rotor 28 and providing more work at the compressor rotor 30, the compressor rotor 32 may rotate at slower speeds and, thus, the compressor rotor 32 has lessor stress due to the lesser speeds and, thus, can experience higher temperatures at a downstream end.

In addition, the architecture disclosed here can provide additional flexibility to provide a family of gas turbine engines where some models have the booster compressor 28 and some models are modified to operate without the booster.

As an example, should an aircraft suggest a gas turbine engine with a lower thrust owing to the lower maximum takeoff gross weight of the aircraft at take-off and thus a lower airflow through the core of the engine air, the booster compressor rotor 28 may be eliminated and the remaining architecture utilized with the fan drive turbine rotor 38 driving the fan 22 through the gear reduction 24.

This provides economic benefits in reducing engineering and development costs and inventory issues for the manufacturer of gas turbine engines. The same manufacturer could realize production efficiencies by then offering a higher thrust model, with the booster compressor forcing higher core airflow and therefore higher fuel flows can be added, producing higher core and fan thrust, that would serve a higher gross weight aircraft with very few changes in the rest of the engine.

The two aircraft might require quite different sea-level takeoff thrust and the engines might appear to be quite different in fan size (22) and the external components such as wire harnesses and cabin pressurization plumbing and valves. But there would be large development and inventory savings in all parts in the core engine designated as module 30, 32, 40, 42 and perhaps even 38.

These modules represent the greatest portion of the manufacturer's development cost, production cost, inventory costs, warranty costs and overhaul costs and so commonality is a great benefit here.

As an example, with this method, as much as 80% of both engines parts aft of a flange in front of the intermediate compressor 30 can be common.

The engine 20 in one example is a high-bypass geared aircraft engine. In a further example, the engine 20 bypass ratio is greater than about six (6), with an example embodiment being greater than about ten (10). The geared architecture 24 is an epicyclic gear train, such as a planetary gear system or other gear system, with a gear reduction ratio of greater than about 2.3 and the low pressure turbine 38 has a pressure ratio that is greater than about five. In one disclosed embodiment, the engine 20 bypass ratio is greater than about ten (10:1), the fan diameter is significantly larger than that of the low pressure compressors 28/30, and the low pressure turbine 38 has a pressure ratio that is greater than about five 5:1. Low pressure turbine 38 pressure ratio is pressure measured prior to inlet of low pressure turbine 46 as related to the pressure at the outlet of the low pressure turbine 38 prior to an exhaust nozzle. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFCT’)”—is the industry standard parameter of 1 bm of fuel being burned divided by 1 bf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7 ° R)]^{0.5}. The “Low corrected fan tip speed” as disclosed herein according to one non-limiting embodiment is less than about 1150 ft/second.

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
a first turbine rotor positioned upstream of a second intermediate turbine rotor and a third turbine rotor being positioned downstream of the first and second turbine rotors;
a fan rotor and three compressor rotors, with an upstream one of said three compressor rotors being connected to rotate on a shaft with the third turbine rotor, and said third rotor also driving said fan rotor through a gear reduction, and an intermediate one of said three compressor rotors for being driven by said second intermediate turbine rotor, and a third one of said three compressor rotor downstream of said upstream and intermediate compressor rotors and being driven by said first turbine rotor;
said fan rotor for delivering air into a bypass duct as propulsion air and for delivering air to said upstream compressor rotor as core air flow and a ratio of said bypass air flow to said core air flow being greater than or equal to about 10.0; and
a variable turbine vane positioned upstream of said first turbine rotor to allow the selective control of an overall pressure ratio, said variable turbine vane is utilized to reduce an overall pressure ratio at take-off conditions.

2.-3. (canceled)

4. The gas turbine engine as set forth in claim 1, wherein an intermediate and third pressure ratio across the intermediate and third compressor rotors with said intermediate and third pressure ratio across said intermediate and third compressor rotors being greater than or equal to about 18.0 and less than or equal to about 36.0.

5. The gas turbine engine as set forth in claim 4, wherein said intermediate compressor rotor provides a compression ratio greater than or equal to about 8.0 and less than or equal to about 10.0.

6. The gas turbine engine as set forth in claim 5, wherein said third compressor rotor provides a compression ratio of greater than or equal to about 4.0 and less than or equal to about 6.0.

7. The gas turbine engine as set forth in claim 6, wherein said upstream compressor rotor provides a compression ratio of greater than or equal to about 2.5 and less than or equal to about 4.0.

8. The gas turbine engine as set forth in claim 7, wherein a total pressure ratio across said three compressor rotors is greater than or equal to about 45.0.

9. The gas turbine engine as set forth in claim 8, wherein the total pressure ratio across said three compressor rotors is less than or equal to about 144.0.

10. (canceled)

11. The gas turbine engine as set forth in claim 9, wherein the gear ratio across said gear reduction is greater than or equal to about 2.6.

12.-18. (canceled)

19. The gas turbine engine as set forth in claim 17, wherein the gear ratio across said gear reduction is greater than or equal to about 2.6, and the air reaching said upstream compressor rotor passing to said intermediate one of said three compressor rotors.

20.-22. (canceled)
